(19) United States
(12) Patent Application Publication
(10) Pub. No.: US 2007/0030531 A1
(43) Pub. Date: Feb. 8, 2007

(54) Method and device for contact images sensor (CIS) identification

(75) Inventor: Guo Hui Cao, Jiangsu (CN)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/493,870

(22) Filed: Jul. 25, 2006

(30) Foreign Application Priority Data
Jul. 26, 2005 (TW) TW94125285

(51) Int. Cl. H04N 1/04

(52) U.S. Cl. 358/474

(57) ABSTRACT

A method and device of contact image sensor (CIS) identification of a scanner is disclosed in the invention. First, a CIS type is selected. A driving method associated to the selected CIS type is used to drive the CIS, and the scanner performs a predetermined scan action. When the output characteristics of the CIS act as the selected CIS type, the CIS type is set as selected thereof. When the output characteristics of the CIS don't act as the selected CIS type, another CIS type is selected, and again a driving method associated to the selected CIS type is used to drive the CIS, and the scanner performs a predetermined scan action.

### BACKGROUND

The invention is related to scanners and, more particularly, to a method and device providing contact image sensor (CIS) identification.

CISs in scanners vary in specification according to different suppliers. Characteristics of CISs comprising valid pixel count, starting address of valid pixel and driving timing, etc. can vary with specification. Accurate CIS identification is required before scanning. A conventional method of CIS identification is provides I/O signals corresponding to a predetermined logic value. For example, when 2 CISs, CIS0 and CIS1, are compatible with a certain scanner, an I/O signal pulled high indicates a CISO, and low indicates a CIS1. For scanners with various CIS compatibilities, numerous I/O signals are required such that system resources are occupied. Furthermore, changing preset logic values associated with different CISs, requires BOM (bill of material) modification, consuming inventory and production resources during manufacture.

### SUMMARY

In a method and device for contact image sensor (CIS) identification, CIS type is selected and a driving method corresponding thereto drives the CIS, and scanning takes place. When the characteristics output by the CIS correspond to the selected CIS type, the CIS type is set as selected, and if not, another CIS type is selected, with corresponding driving method associated.

It is to be understood that both the foregoing general description and the following detailed description are exemplary and explanatory only and are not restrictive of the invention, as claimed.

### DESCRIPTION OF THE DRAWINGS

The accompanying drawings, which are incorporated in and constitute a part of this specification, illustrate embodiments of the invention and, together with the description, serve to explain the features, advantages, and principles of the invention.

FIG. 1 is a block diagram of a scanner according to one embodiment of the invention.

FIG. 2 is a flowchart of a method of CIS type identification performed by detector 13 in FIG. 1.

### DETAILED DESCRIPTION

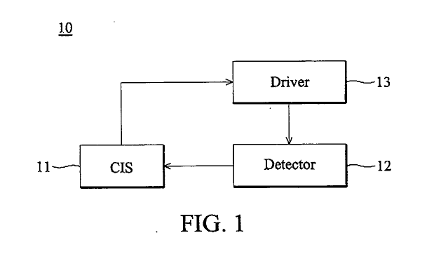

FIG. 1 is a block diagram of a scanner 10 according to an embodiment of the invention, comprising CIS 11, timing driver 12 and detector 13. Timing driver 12 delivers timing signals to CIS 11.

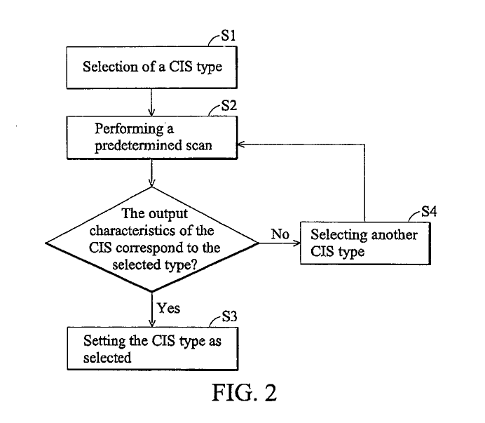

Detector 13 detects the type of CIS 11 upon scanner initialization. FIG. 2 is a flowchart of a method of CIS type identification performed by detector 13 in FIG. 1. Detector 13 selects one type that CIS 11 may be, and controls the timing driver to deliver the associated timing signals thereof (step S1. Detector 13 then directs the scan to begin (step S2). CIS 11 then outputs a pixel data stream according to the characteristics of received timing signal and the scan object. Detector 13 checks if the pixel data stream represents the characteristics output by the currently type of CIS. If the result is satisfactory, detector 13 sets the CIS type as the currently type. If not, detector 13 selects another type, and the process is repeated.

For example, for a scanner with 2 types of CIS compatibility, CIS A and CIS B, associated with different timings, TIMING A and TIMING B, respectively, when the 2 CIS types receive different timings respectively and scan one line of a standard blank document, the output timing is as shown in Table 1.

TABLE 1

| | TIMING A | TIMING B |
|---|---|---|
| CIS A | 0˜27 pixel < 5 (invalid) | All pixels = 0 |
| | 28˜last pixel > 100 | |
| CIS B | All pixels = 0 | 0˜187 pixel < 5 (invalid) |
| | | 188˜last pixel > 100 |

As shown, when detector 13 directs the timing driver to deliver TIMING A signals and the scanner scans one line of a document, the first 28 pixels of the pixel stream output by CIS 11 are invalid, and the others valid, then CIS 11 is identified as CIS A. Similarly, when detector 13 directs the timing driver 12 delivering TIMING B signals and the scanner scans one line of a document, the first 187 pixels of the pixel stream output by CIS 11 are invalid, and the others valid, then CIS 11 is identified as CIS B.

The method disclosed uses starting location of valid pixels in a pixel stream to identify CIS type. Other output characteristics varying between CIS types can also be used to identify the CIS type, such as pixel count of a pixel stream.

The method of the present invention, or certain aspects or portions thereof, may take the form of program code (i.e., instructions), wherein when the program code is executed by a machine, such as a computer, the machine becomes an apparatus for practicing the invention. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. Those skilled in the technology can still make various alterations and modifications without departing from the scope and spirit of this invention. Therefore, the scope of the present invention shall be defined and protected by the following claims and their equivalents.

What is claimed is:

1. A method for contact image sensor (CIS) identification in a scanner, comprising:
selection of a CIS type;
driving a CIS using a method corresponding to the selected CIS type and directing the scanner to perform a predetermined scan;
setting the CIS type as selected when the output characteristics of the CIS correspond to the selected type, and selecting another CIS type and initialing a scan again when the output characteristics do not.

2. The method as claimed in claim 1, wherein the predetermined scan comprises scanning one line of a scan target.

3. The method as claimed in claim 1, wherein the driving method comprises transmission of driving signals at a timing corresponding to the selected CIS type.

4. The method as claimed in claim 1, wherein the output characteristics of the CIS comprise a valid pixel count of a pixel stream.

5. The method as claimed in claim 1, wherein the output characteristics of the CIS comprise a starting address of valid pixel in a pixel stream.

6. A machine-readable computer program providing a method for contact image sensor (CIS) identification in a scanner, comprising:
selection of a CIS type;
driving a CIS using a method corresponding to the selected CIS type and directing the scanner to perform a predetermined scan;
setting the CIS type as selected when the output characteristics of the CIS correspond to the selected type, and selecting another CIS type and initialing a scan again when the output characteristics do not.

7. The machine-readable computer program as claimed in claim 6, wherein the predetermined scan comprises scanning one line of a scan target.

8. The machine-readable computer program as claimed in claim 6, wherein the driving method comprises transmission of driving signals at a timing corresponding to the selected CIS type.

9. The machine-readable computer program as claimed in claim 6, wherein the output characteristics of the CIS comprise a valid pixel count of a pixel stream.

10. The machine-readable computer program as claimed in claim 6, wherein the output characteristics of the CIS comprise a starting address of valid pixel in a pixel stream.

11. A CIS driving device of a scanner, comprising:
a driver delivering driving signals with various timings corresponding to different CIS types; and
a detector directing the driver to deliver driving signals with timings corresponding to each CIS types in turn when the scanner repeats a predetermined scan, and monitoring the output of the CIS; when characteristics output by the CIS corresponded to selected CIS type, the detector sets CIS type as selected.

12. The CIS driving device as claimed in claim 11, wherein the output characteristics of the CIS comprises a valid pixel count of a pixel stream.

13. The CIS driving device as claimed in claim 11, wherein the output characteristics of the CIS comprises a starting address of valid pixel in a pixel stream.
